(19) United States
(12) Patent Application Publication
(10) Pub. No.: US 2017/0048176 A1
(43) Pub. Date: Feb. 16, 2017

(54) COMMUNITY DIRECTORY FOR DISTRIBUTED POLICY ENFORCEMENT

(71) Applicant: Actiance, Inc., Redwood City, CA (US)

(72) Inventors: John Onusko, Garden Valley, CA (US); Steven White, Woodinville, WA (US); Brian Babin, Charlotte, NC (US)

(21) Appl. No.: 15/339,720

(22) Filed: Oct. 31, 2016

Related U.S. Application Data
(63) Continuation-in-part of application No. 14/694,736, filed on Apr. 23, 2015.
(60) Provisional application No. 61/983,168, filed on Apr. 23, 2014.

(51) Int. Cl. H04L 12/58; H04M 3/42; H04L 29/08; H04L 29/06

(52) U.S. Cl. CPC H04L 51/12; H04L 65/1076; H04L 51/046; H04M 3/42144; H04L 67/10

(57) ABSTRACT

An active compliance engine used to control/restrict communication or collaboration is provided. The active compliance engines may include a content inspection module that inspects the content of a message for inappropriate language or information. Content could be an instant message, content of an attached file, speech from a voice session, sign language from a video session, or content shared through desktop sharing. The active compliance engines may include a content tagging module that tags inspected content. Ethical wall rules are used in the inspection of participants to a communication to see whether they are allowed to communicate or collaborate with each other. A communication management module manages communications or event based on an inspection.

### CROSS-REFERENCES TO RELATED APPLICATIONS

This application is a continuation-in-part of U.S. patent application Ser. No. 14/694,736, filed Apr. 23, 2015, and entitled “DISTRIBUTED POLICY ENFORCEMENT FOR ENTERPRISE COMMUNICATIONS,” which claims priority to and the benefit of U.S. Provisional Patent Application No. 61/983,168, filed Apr. 23, 2014, and entitled “DISTRIBUTED POLICY ENFORCEMENT FOR ENTERPRISE COMMUNICATIONS,” the disclosures of which are hereby incorporated by reference for all purposes.

### BACKGROUND OF THE INVENTION

The present disclosure relates generally to the field of information security infrastructure. Specifically presented are methods and systems for providing a community directory for distributed policy enforcement of enterprise communications.

Companies are striving to connect across disparate enterprise computer systems to form communities. This is so that users can access and share information using enterprise resources no matter where they might be or their employment at a given firm. This can allow employees of various organizations to collaborate more efficiently. Of course, security is one concern in allowing access to a company's internal servers from outside as well has what information may be shared with whom.

Accordingly, what is desired is to solve problems relating to policy enforcement for enterprise communications, some of which may be discussed herein. Additionally, what is desired is to reduce drawbacks relating to distributed policy enforcement for enterprise communications, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 depicts a simplified diagram of an enterprise-based architecture for implementing one of the embodiments.

FIG. 2 depicts a simplified diagram of a distributed architecture for implementing one of the embodiments.

FIG. 3 is a block diagram of interactions between an active compliance engine and a community directory in one embodiment according to the present invention.

FIG. 4 is a simplified flowchart of a method for synchronizing with a community directory in one embodiment.

FIG. 5 is a block diagram showing relationships between data model elements of a community directory in one embodiment.

FIG. 6 is a simplified flowchart of a method for defining policies using a community directory in one embodiment.

FIG. 7 is a simplified flowchart of a method for distributed policy enforcement for enterprise communications in one embodiment.

FIG. 8 illustrates one scenario of the method of FIG. 7 for distributed policy enforcement for enterprise communications in one embodiment.

FIG. 9 illustrates how communications are managed in one example for the scenario of FIG. 8 for distributed policy enforcement for enterprise communications in one embodiment.

FIG. 10 illustrates how communications are managed in another example for the scenario of FIG. 8 for distributed policy enforcement for enterprise communications in one embodiment.

FIG. 11 illustrates cloud-based distributed policy enforcement for enterprise communications in one embodiment.

FIG. 12 illustrates distributed active compliance between on-premise and cloud resources for distributed policy enforcement for enterprise communications in one embodiment.

FIG. 13 depicts a simplified diagram of a distributed system for implementing one of the embodiments.

FIG. 14 is a simplified block diagram of components of a system environment by which services provided by the components of an embodiment system may be offered as cloud services, in accordance with an embodiment of the present disclosure.

FIG. 15 illustrates an exemplary computer system, in which various embodiments of the present invention may be implemented.

### DETAILED DESCRIPTION OF THE INVENTION

### I. Introduction

In the following description, for the purposes of explanation, specific details are set forth in order to provide a thorough understanding of embodiments of the invention. However, it will be apparent that various embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments. The figures and description are not intended to be restrictive. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” or “computer-readable medium” includes, but is not limited to, portable or non-portable storage devices, optical storage devices, wireless channels, and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable or computer-readable medium. One or more processors may perform the necessary tasks.

Systems depicted in some of the figures may be provided in various configurations. In some embodiments, the systems may be configured as a distributed system where one or more components of the system are distributed across one or more networks in a cloud computing system. In further embodiments, the systems may be configured as a single system where one or more components of the system incorporated into a single structure or package.

### II. Terminology

The following terms and phrases, for the purposes of explanation, are set forth in order to provide a thorough understanding of embodiments of the invention. The terms and phrases are not intended to be restrictive and, unless otherwise redefined, are intended to include their plain meaning referring to the ordinary and customary meaning given to the term by those of ordinary skill in the art. Rather, the ensuing terminology of the exemplary embodiments will provide those skilled in the art with an enabling description for implementing an exemplary embodiment.

A communication—as used herein a communication refers to the act of imparting or exchanging of information, a collaboration, or the means of connection between entities that are parties to a communication or collaboration. Some examples of a communication include a voice call, a conference call, a Voice over Internet Protocol (VoIP) call, a video call, an instant messaging (IM) session, a persistent chat discussion, etc. together with the means that provide such.

A communication event—as used herein a communication event refers to one or more actions or interactions associated with a communication. Some examples of a communication event include establishing a communication session, adding a user to a multi-party communication, inviting a user to join a communication (e.g. invite or add a user to a chat room membership), updating user metadata, etc.

In various embodiments, communications and associated communication events (e.g., their establishment, content, means, and lifecycle) can be controlled by ethical wall rules using an active compliance engine. Active compliance engine—as used herein an active compliance engine refers to hardware and/or software elements that control/restrict communications or communication events. In one aspect, an active compliance engine includes a content inspection module, a content tagging module, a repository of ethical wall rules, and a communication manager module.

Ethical wall rules—as used herein an ethical wall rule refers to one or more rules, inspection sets, or decision points used to determine whether an inspection of a communication or communication event satisfies predetermined criteria and what action to take with respect to the communication or communication event when the predetermined criteria are satisfies. For example, an inspection of participants of an instant messaging session may be made according to one or more ethical wall rules to see if one or more of the participations are allowed to communicate or collaborate with each other. In another example, an inspection may be made to determine whether the subject matter of the conversation between the participants is prohibited.

A content inspection module as used herein refers to hardware and/or software elements that inspect a communication or collaboration or communication event to determine whether an inspection satisfies a set of ethical wall rules. The content inspection module may inspect contents of a communication, metadata associated with the communication, or determine a type or category of a communication event. The content inspection module may include one or more additional modules or plugins to handle a variety of types or means of communicating in order to perform an inspection, such as for electronic messages (e.g., email and instant messages), speech from a voice session, sign language from a video session, or content shared through desktop sharing applications. The content inspection module may include or have access to a variety of types or forms of rules, inspection sets, or decision points used to determine whether the inspection satisfies the predetermined criteria.

A content tagging module as used herein refers to hardware and/or software elements that tag a communication or communication event. In one aspect, based on one or more recommendations or decisions by the content inspection module, the content tagging module may tag or annotate the communication, content of the communication, associated metadata, and/or associated communication event with one or more tags. Some examples of tags include permission-type tags that identify one or more permissions applicable to the inspection, such as blocked or allowed, characterization-type tags that characterize a communication, or its contents or participants, privilege or confidentiality tags, or the like.

A communication manager module as used herein refers to hardware and/or software elements that manage a communication or collaboration or communication event based on an inspection and/or associated tags. The communication manager module may manage an inspection, for example, by blocking or allowing a communication to be initiated or to continue or by performing one or more actions based on a communication event. The communication manager module may further manage an inspection, for example, by generating one or more notifications to one or more entities that are not participating in a communication or collaboration associated with the inspection. In some aspects, the communication manager module may communicate with a variety of devices in order to manage communications, provide record keeping and audit logs, provide notification of compliance or non-compliance, and the like.

Historically, ethical wall rules have been applied specifically within a firm. In other words, a firm can write rules that allow/disallow communications between different groups associated with the firm. The different groups can be internal groups (internal traders with internal rate-setters) or groups between firms (Bank-A traders with Bank-B rate-setters). An active compliance engine of the firm then controls/restricts communications or communication events within the firm using the ethical wall rules.

In embodiments, enforcement of distributed ethical wall rules refers to performing communications with among multiple active compliance engines each associated with one or more entities or organizations or between logical partitions each associated with at least one entity or organization that is managed by an active compliance engine. Each entity or organization can implement or host all or part of the active compliance engine for communication with the community. Thus, communications and associated communication events (e.g., their establishment, content, means, and lifecycle) can be controlled in a distributed manner across a community using the active compliance engine of each member of the community and a community directory.

A community directory as used herein refers to hardware and/or software elements that provide information associated with entities or organizations participating in one or more communities that engage in one or more communications. The community directory hosts information about all users, participants, etc. in the community who fall under restrictions of the entity or organization. The community directory of multiple entities or organizations can be leveraged by the active compliance engine to enforce policies in a community across disparate users, entities, and organizations. Some examples of information stored by a community directory can include local and global identifiers for users (e.g., employee ID), First/Last Name, Firm/Division, communication address (email, IM ID or buddy name, phone number, etc.) for specific networks (Skype, Lync IM, Thompson-Reuters Eikon ID, Enterprise Phone number, etc.), role-based or permission based attributes (e.g., user is a “Foreign-Exchange Trader”, “Foreign-Exchange Rate-Setter” . . . ), and the like.

### III. Architecture for Enforcement of Distributed Ethical Wall Rules

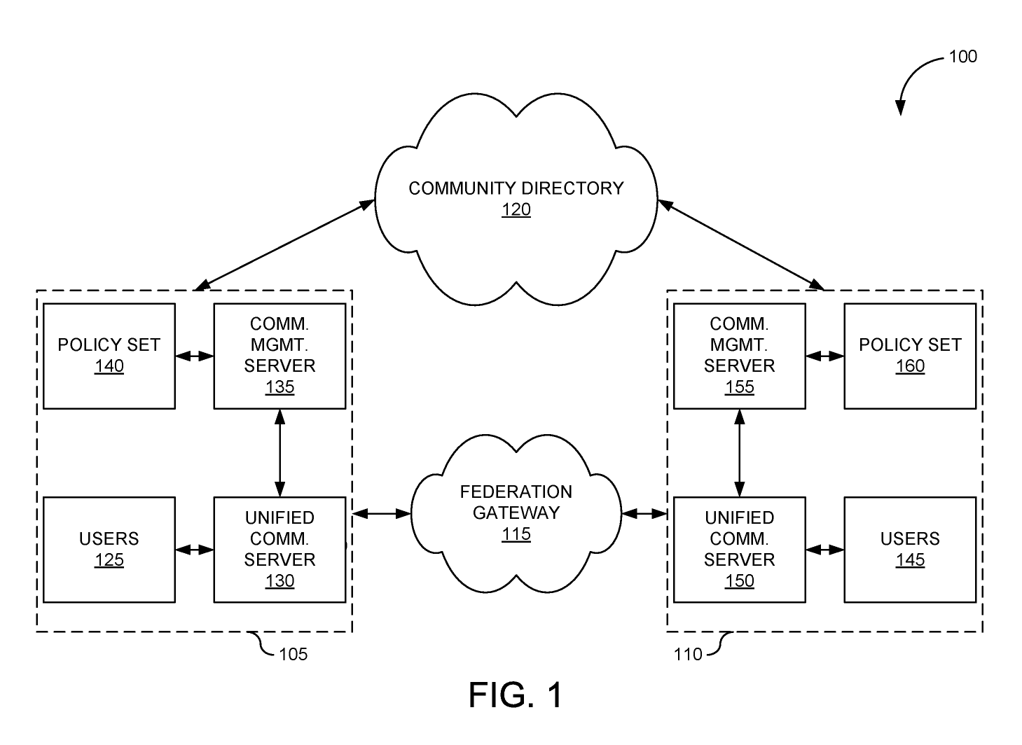

FIG. 1 depicts a simplified diagram of enterprise-based architecture 100 for implementing one of the embodiments. FIG. 1 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

In this example, architecture 100 operates to allow the active compliance engine of each member of the community to communicate to provide distributed enforcement of ethical wall rules. Architecture 100 includes enterprise 105 (e.g., “Act Bank”), enterprise 110 (e.g., “FT Investments”), federation gateway 115, and community directory 120. Enterprise 105 and enterprise 110 are representative of organizations that participate in a community that utilizes federation gateway 115 and community directory 120 for distributed policy enforcement of federated communications. Enterprise 105 includes unified communications users 125 that communicate using unified communications server 130 (e.g., “Lync pool”). Enterprise 105 further includes communications management server 135 (e.g., “Vantage”) that implements and enforces policy set 140 for communications and/or communication events associated with users 125 and server 130. Similarly, enterprise 110 includes unified communications users 145 that communicate using unified communications server 150 (e.g., “Sametime pool”). Enterprise 110 further includes communications management server 155 (e.g., “Vantage”) that implements and enforces policy set 160 for communications and/or communication events associated with users 145 and server 150. Policy sets 140 and 160 may be applied by communications management server 135 and communications management server 155 at the internal level to manage communications and/or communication events within an organization's infrastructure or prior to leaving the organization's infrastructure via federation gateway 115.

Federation gateway 115 includes hardware and/or software elements that allow communication between users 125 and users 145. To be federated means users are able to send messages from one network to the other. This is not the same as having a client that can operate with both networks. Users 125 and 145 interact with both independently. In part to enable this, information about each organization is collected in community directory 120. Community directory 120 includes hardware and/or software elements that manage and provide data associated with members of a community. A community can be formed between one or more members. User data from members of the community can be created at or uploaded to community directory 120. User data about members of the community can be retrieved when needed to make decisions regarding communications and/or communication events prior to leaving the organization's infrastructure via federation gateway 115.

In one embodiment, communications management server 135 and communications management server 155 (e.g., also known as an active compliance engine or ethical wall engine) can communicate with other active compliance engines of other organizations to determine ethical wall rules in other firms. Communications management server 135 and communications management server 155 can use policies defined for the community as well as for specific members or users defined by other organizations to control communications and/or communication events. Accordingly, policy sets 140 and 160 may be applied by communications management server 135 and communications management server 155 at the federation level to manage communications and/or communication events within an organization's infrastructure or prior to leaving the organization's infrastructure via federation gateway 115.

In one aspect, in order for a communication to be initiated or to host participants, or for a communication event to occur, communications management server 135 and communications management server 155 coordinate to allow the communication or communication event to occur. If one or more active compliance engines determines that one or more ethical wall rules have not be satisfied, one or more conditions have not been met, or other predetermined criteria fails to be satisfied, the communication or communication event will NOT be allowed.

In various embodiments, the disallowing active compliance engine or another active compliance engine can generate one or more notifications that return a reason when an ethical wall rule disallows a communication or communication event. For example, a notification may be generated and sent using one or more communication mediums or modalities that indicates, “C-Bank does not allow this action because it does not allow traders to communicate with more than 3 firms.”

In some embodiments, each active compliance engine proactively monitors changes to ethical wall rules. For example, if a set of rules have changed between an ethical wall check, a communication or communication event can be immediately managed according to any changed rules. For example, a role associated with a user may change to a role where the user us NOT allowed to communicate with one or more external traders. Active compliance engine may cause the user to be removed from a communication, such as a telephone call or instant messaging session.

Where select participant firms do NOT have an ethical wall engine or an active compliance engine that is compatible with or in communication with other active compliance engines in a community, the active compliance engine of one firm cannot manage (e.g., block or explicitly allow) a communication in a distributed sense. Ethical wall rules of other firms may account for these participants (whether they are known or not known in a community directory). In one aspect, an active compliance engine of a not connected firm can block a communication event on its side, either allowing or blocking a user from a given communication.

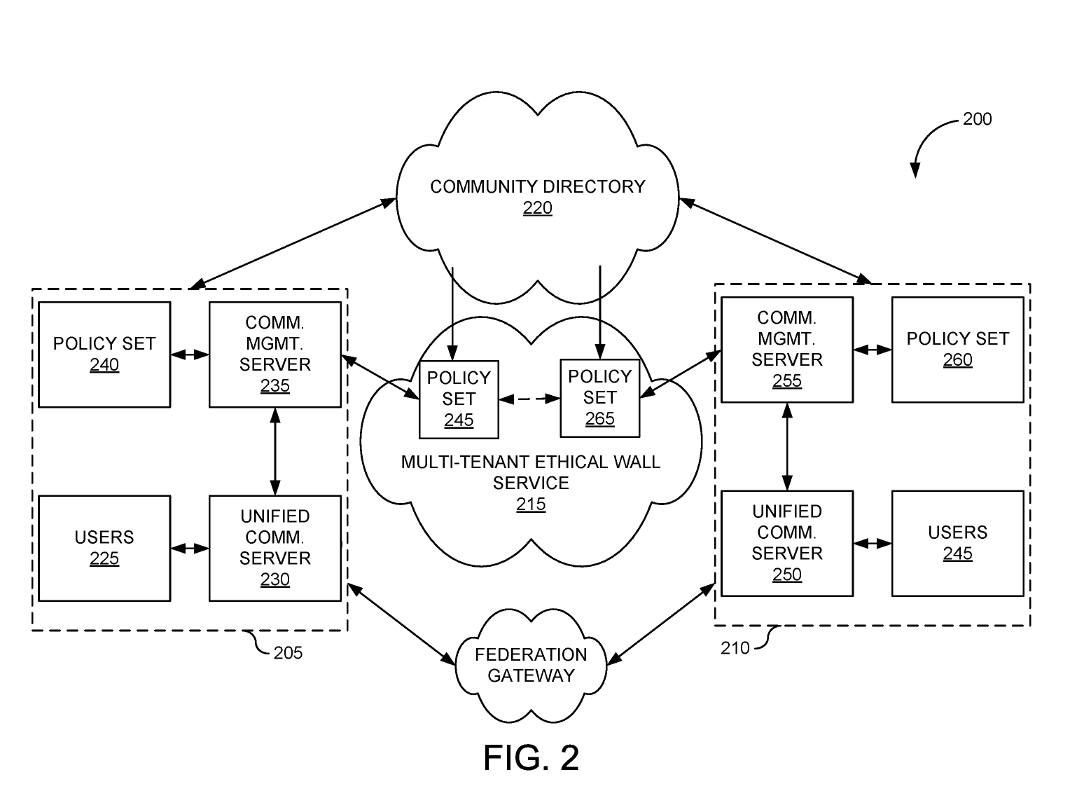

FIG. 2 depicts a simplified diagram of distributed architecture 200 for implementing one of the embodiments. FIG. 2 may merely be illustrative of an embodiment or implementation of an invention disclosed herein should not limit the scope of any invention as recited in the claims. One of ordinary skill in the art may recognize through this disclosure and the teachings presented herein other variations, modifications, and/or alternatives to those embodiments or implementations illustrated in the figures.

In this example, architecture 200 operates to allow all or part of the active compliance engine of each member of the community to operate in the cloud to provide distributed enforcement of ethical wall rules. Architecture 200 includes enterprise 205 (e.g., “Act Bank”), enterprise 210 (e.g., “FT Investments”), multi-tenant ethical wall service 215, and community directory 220. Enterprise 205 and enterprise 210 are representative of organizations that participate in a community that utilizes multi-tenant ethical wall service 215 and community directory 220 for distributed policy enforcement of federated communications. Enterprise 205 includes unified communications users 225 that communicate using unified communications server 230 (e.g., “Lync pool”). Enterprise 205 further includes communications management server 235 (e.g., “Vantage”) that implements and enforces policy set 240 for communications and/or communication events associated with users 225 and server 230. Similarly, enterprise 210 includes unified communications users 245 that communicate using unified communications server 250 (e.g., “Sametime pool”). Enterprise 210 further includes communications management server 255 (e.g., “Vantage”) that implements and enforces policy set 260 for communications and/or communication events associated with users 245 and server 250.

Multi-tenant ethical wall service 215 includes hardware and/or software elements that provided policy-based management of communication between users 225 and users 245. In part to enable this, information about each organization is collected in community directory 220 and utilized in policy decisions. User data about members of the community can be retrieved when needed to make decisions regarding communications and/or communication events.

Multi-tenant ethical wall service 215 can then communicate policy information from the communications management server 235 and communications management server 255. For example, the communications management server 235 may communicate all or a subset of policies from the policy set 240 to the multi-tenant ethical wall service 215. The multi-tenant ethical wall service 215 may maintain the policies for users 225 in enterprise 205 in policy set 270. In some instances, the communications management server 235 modifies the policies from policy set 240 before communicating out the policies to the multi-tenant ethical wall service 215. These modifications to the policies for the users 225 may be based on the global policies set for the enterprise 205. Similarly, the communication management server 255 may communicate all or a subset of policies from the policy set 260 to the multi-tenant ethical wall service 215. The multi-tenant ethical wall service 215 may maintain the policies for users 245 in enterprise 210 in policy set 270. In some instances, the communications management server 255 modifies the policies from policy set 260 before communicating out the policies to the multi-tenant ethical wall service 215. These modifications to the policies for the users 245 may be based on the global policies set for the enterprise 210. In some embodiments, the policy set 265 and policy set 270 may be from any other trusted source besides the communications management server (235 and 255), such as the community directory 220 or another trusted cloud. In some embodiments, the rules associated with the policy set 270 and policy set 265 may be validated for consistency before they are applied against communities comprising users 225 from enterprise 205 and users 245 from enterprise 210.

In this example, federation gateway shown in FIG. 2 may operate in addition to the multi-tenant ethical wall service 215 to service communication between the users 225 and users 245. Communication may be based on a web API or other distributed call.

### IV. Community Directory for Enforcement of Distributed Ethical Wall Rules

In one embodiment, multi-tenant ethical wall service 215 and community directory 220 is a cloud-based directory and policy engine for federated communications. A cloud framework can be provided for hosting the application. This can be similar to communications management server 135, communications management server 155, communications management server 235, and communications management server 255. Multiple customers can be provisioned and have their own view to manage users and policies, report on activity, and perform other necessary functions.

A community can be formed using community directory 220 and members can join. User data from members can be uploaded to community directory 220, such as from an active compliance engine, manually, or alternately, user data can be obtained from some other source (e.g. an independent directory). An API can be supported to upload directory information for the users to be shared for a given member for a given community.

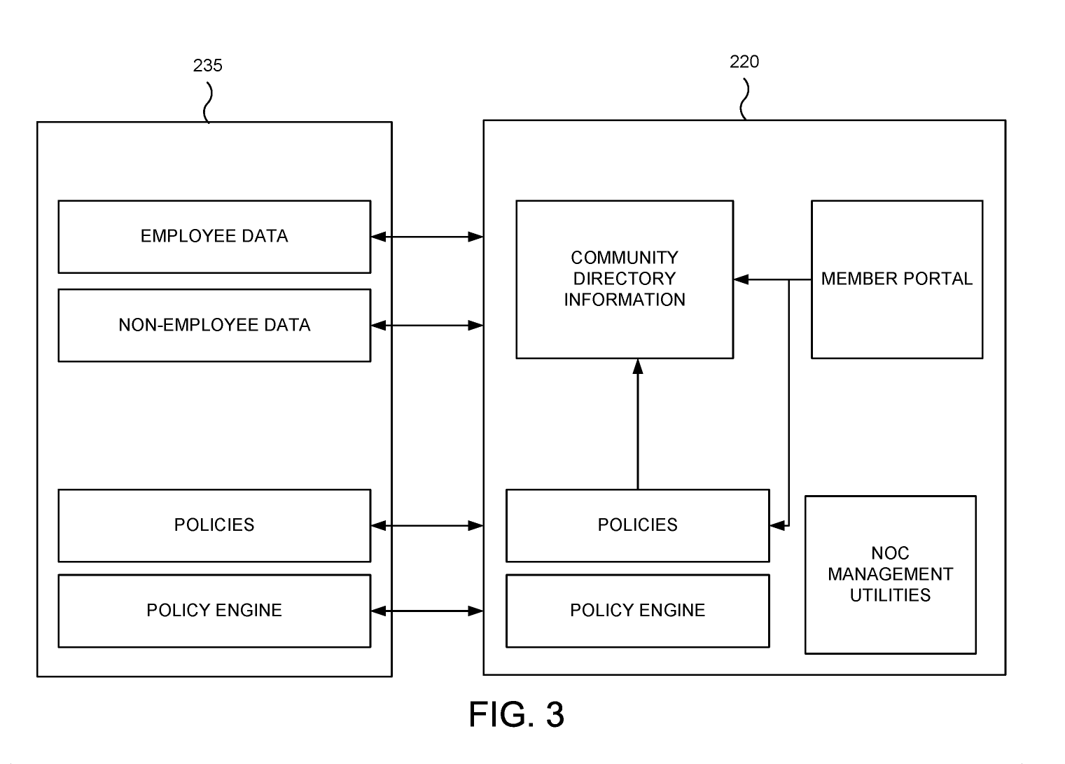

FIG. 3 is a block diagram of interactions between an active compliance engine and a community directory in one embodiment according to the present invention. In this example, communications management server 235 uploads user data (e.g., employee data) to community directory 220. Communications management server 235 can also download non-employee data. If a non-employee participant is encountered in an interaction, communications management server 235 can check whether that participant is known to community directory 220 and download any publicly shared details for that user.

Community directory 220 can support a member portal where a customer can view and edit member details, such as name, attributes, number of users, community/communities to which the member belongs. A member can also view and edit community attributes, community details (for each community to which the member belongs), public attributes of community members, number of users, etc. A member can further search or browse a user directory of their own organization or other organizations. In one embodiment, a member can provide a policy definition, manage enablement of policies, instantiate community policies (e.g., take a shared policy defined at the community level and activate it for the member). The member can manage users by extending a user definition, organizational unit definition, define custom attributes, or the like.

Community directory 220 can further support a member portal NOC utilities to administer the directory. These utilities can manage the system. They may be scripts or have an associated user interface (UI). Some examples of administrative tasks are global level functions, such as create a community, update a community, delete a community (and all associated objects), view community, etc. An administrator can create/update/delete a portal user and assign access privileges. Some examples of administrative tasks are member level functions, such as view member definition, object extensions (custom attributes), view and interact with the member directory, view and manage policies, etc.

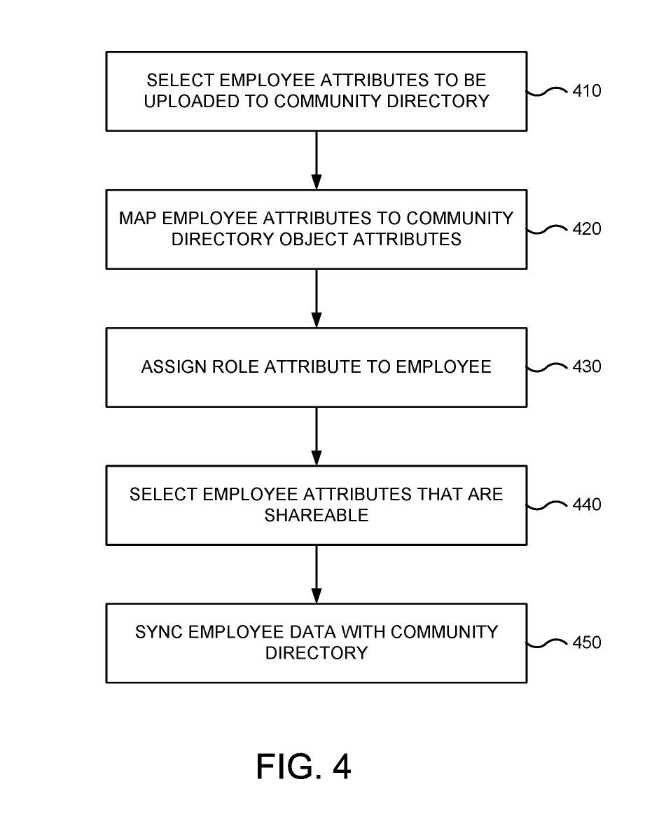

FIG. 4 is a simplified flowchart of method 400 for synchronizing with a community directory in one embodiment. Implementations of or processing in method 400 depicted in FIG. 4 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 400 depicted in FIG. 4 begins in step 410.

In step 410, one or more employee attributes are selected to be uploaded to a community directory. In step 420, employee attributes are mapped to community directory object attributes. Table 1 provides a sample map between employee attributes and community directory attributes.

TABLE 1

| Employee Attribute | User Attribute |
|---|---|
| Employee ID | EmployeeID or Email |
| Employee Email | Email |
| First Name | FirstName |
| Middle Name | MiddleName |
| Last Name | LastName |
| Display Name | DisplayName |
| Initials | Initials |
| Role | Role |
| Title | Title |
| Company | Company |
| Division | Division |
| Department | Department |
| Building | Building |
| Image | Image |
| Address | Address |
| City | City |
| State | State |
| Country | Country |
| Office Phone | OfficePhone |
| Secondary Office Phone | SecondaryOfficePhone |
| Mobile Phone | MobilePhone |
| Home Phone | HomePhone |
| Other Phone | OtherPhone |
| AIM Buddy Name | ID.AIM |
| MSN Buddy Name | ID.MSN |
| Yahoo! Buddy Name | ID.Yahoo |
| Sametime Buddy Name | ID.Sametime |
| Alternate Sametime Buddy Name | ID.SametimeAlt |
| Reuters Messenger Buddy | ID.Reuters |
| MicrosoftUC Buddy Name | ID.MicrosoftUC |
| MicrosoftUC Phone Number | ID.MicrosoftUCPhone |
| Jabber Buddy Name | ID.Jabber |
| Google Talk Buddy Name | ID.GoogleTalk |
| BlackBerry PIN | ID.BlackBerryPIN |
| BlackBerry Phone Number | ID.BlackBerryPhone |
| BlackBerry Name_ID | ID.BlackBerryNameID |
| SharePoint Buddy Name | ID.SharePoint |
| Connections Buddy Name | ID.Connections |
| Alternate Connections Buddy Name | ID.ConnectionsAlt |

In step 430, a role is assigned to each employee. In step 440, one or more employee attributes that are shareable are selected. In step 450, synchronize employee data with community directory.

In certain aspects, the non-employee data may be downloaded independent of the upload steps disclosed in blocks 410-450 above.

Communications management server 235 can access community directory 220 using a set of APIs that provide services to upload and download user data, upload policy definitions, and return a policy decision on a given event. Policies are defined in the community and by members to control communications. To begin with, policies are centered on restricting communications between users who should not be allowed to interact, whether permanently (e.g. full ethical wall) or based on the current set of circumstances (e.g. two members are already present in a conversation and the new user would add a third member which is not allowed).

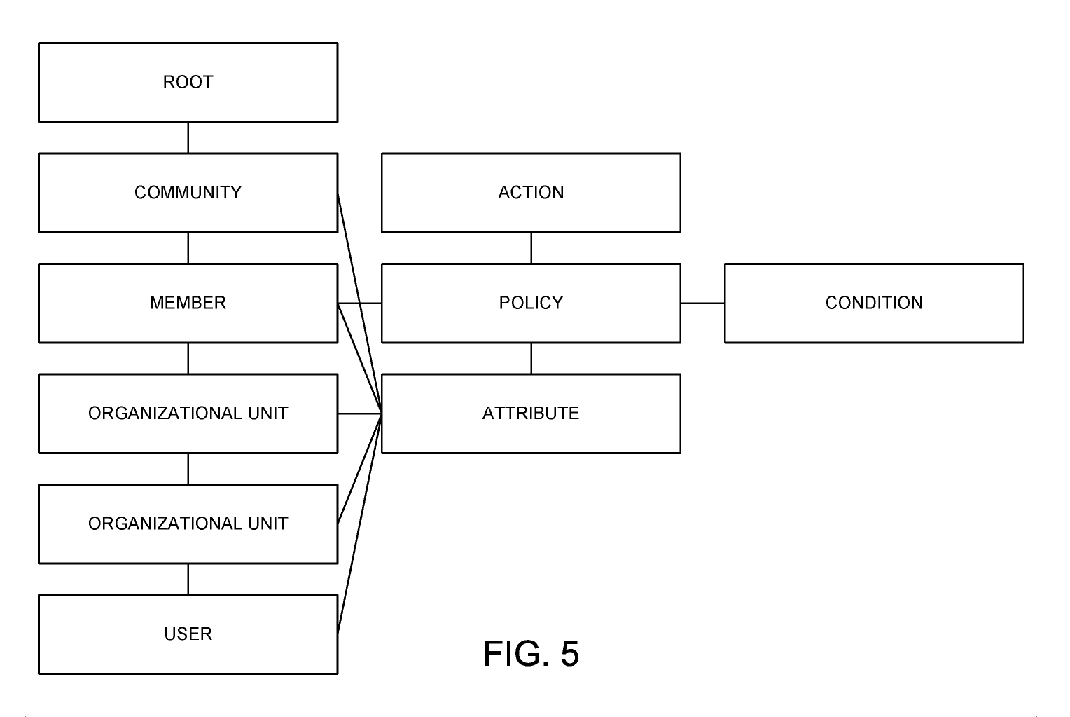

FIG. 5 is a block diagram showing relationships between data model elements of community directory 220 in one embodiment. In this example, a Root Object represents an instance which is a logical deployment. Communities are defined at the Root level. Standard attributes for Community, Member, and User objects can be defined at this level. Attributes designated as inheritable are inherited by lower level objects. Additional attributes can be added at each lower level. A default value for an attribute can be specified and that value is inherited by lower level objects. An attribute value can be overridden at a lower level.

A Community Object consists of zero or more Member Objects. It is possible to have a Community with one Member, though it is not a primary use case. There are Community access roles, such as Owner=Creator of the Community, Administrator=Defined Attributes and manages Member creation, Policy=Creates Community-level Policies and defines taxonomies. These roles control access rights to the Community definition, the ability to assign those rights, and to administer various aspects of the Community. Roles can be customized and new ones created with selected capabilities. The standard Community attributes (defined on the Root) can be extended at this level. Community-specific attributes for Members, OUs, and Users are defined at this level. Values for inherited attributes can be defined to be passed to lower levels.

A Member Object represents an operating entity that belongs to a Community. It will typically represent a firm/company, but could represent different independent divisions of a company that are defined and managed separately. Policies are implemented at the Member level. They reside within a Member but are not attached to any specific object (e.g. User or OU). It is the Attributes of the policy which determine where the policy applies. The standard Member attributes (defined on the Root and Community) can be extended at this level. Member-specific attributes for OUs and Users can be defined at this level. Values for inherited attributes can be defined to be passed to lower levels.

An Organizational Unit (OU) is a container for Users or other OUs. It is created for the convenience of organizing Users within a Member and associating attributes and values to a group of users if desired. OU is optional and can be an arbitrary depth. A Member can choose to have no OUs defined. A Member can choose to define a five level OU hierarchy, if desired. Here, a User belongs to at most one OU. OUs can be used at some point in access roles to restrict who has permissions to create policies, e.g. an Investment Banking manager is allowed to create policies only for users where OU=Investment Banking. The standard OU attributes (defined on the Root, Community, and Member) can be extended at this level. OU-specific attributes for Users can be defined at this level. Values for inherited attributes can be defined to be passed to lower levels.

A User represents a person who belongs to a Member of the Community. A User will have zero or more identities from communication systems being used (historically known as “buddy names”). A User with zero identities will not be affected by policies defined but may exist if they require administrator or policy definition level access for a Member. All attributes and values inherited or specified at the User level are available for Policy definition

Attributes are name, value pairs. Standard attributes are defined for each object level (Root, Community, Member, OU, and User). The attributes can be extended at any level either for that level (e.g. defining an additional attribute at the Member level that applies to that Member) or to apply to lower levels (e.g. defining an additional User attribute at the Member level that applies to all Users for that Member). Attributes values can be defined to be unrestricted (string value) or enumerations (defined set of values allowed). Attributes can be single or multi-valued. Attributes are also designated as mandatory or optional, defining whether it must be assigned a value or not. Role is an example of an enumeration. The Role taxonomy is defined at the Community level since it will be shared by all Members. Each enumeration is assigned a unique name and identifier.

An enumeration can be hierarchical, e.g.:

### FX

Trader

Analayst

A User can be assigned a role of FX/Trader which means they belong to FX as well. A policy where attribute Role=FX would apply to this User as would a policy where Role=FX/Trader. An attribute can be assigned a value at one level to be inherited by lower levels, e.g. the User attribute Country could be set to US at the Member level so that all Users for that Member inherit that value. A defined value can be overridden at a lower level, e.g. the value of Country could be set to UK at a particular OU and hence would apply to all Users in that OU.

Finally, a Policy consists of Attributes, Conditions, and Actions. Attributes determine the Users to which the Policy applies, e.g. Role=FX/Trader. Conditions define operations on Attributes, e.g. count(Member)>2. Actions define the outcome if the Policy matches, e.g. Block. A policy can be defined at the Community level and set to active (applies to all Members) or inactive (made available for Members to activate). This provides a means to create predefined policies for a Community and choose whether Members must enforce them or can choose to use them if they would like. For community-wide policies, it makes sense to leverage the community standardized attributes, as they are designed for this purpose. The community can have a superset of common rules, and Members can leverage the entire set of community rules (enabling only ones that apply to their organization and then adding some rules that only apply to their employees).

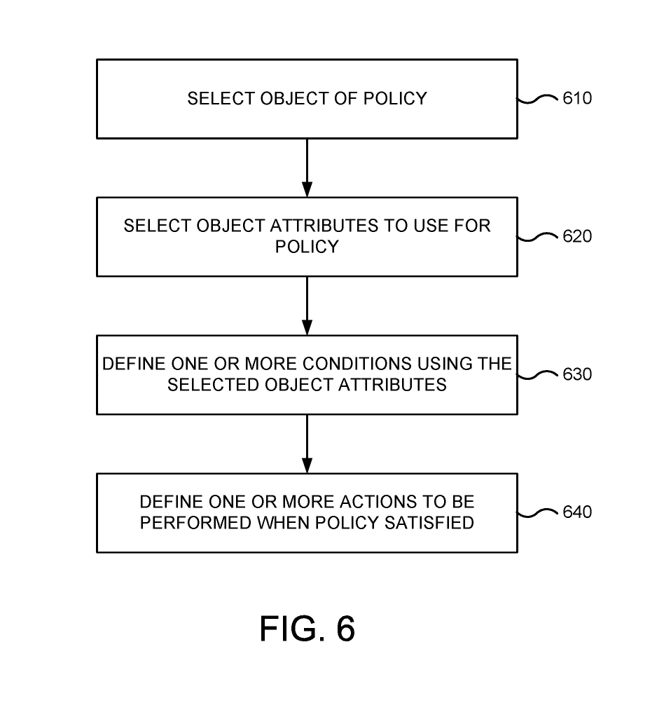

FIG. 6 is a simplified flowchart of method 600 for defining policies using a community directory in one embodiment. Implementations of or processing in method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 610, an object of the policy is selected. In one embodiment, two classes of objects can be included in policies: Members (Tenants) and Participants (User). In step 620, one or more object attributes to use for policy. In step 630, one or more conditions are defined using the selected object attributes.

Policies can support operators for rules clauses that support, for example, User Role Attribute (Role=“FX Trader”), User Country Attribute (Country=“US”), Member Name Attribute (Name=“Acme Bank”). Policies can support “includes” operation for attribute comparisons, for example, Role includes “FX Trader.” Policies can support Count( ) operator with =, >, >=, <, <= operators (e.g., Member.Count( )=2; Member.Count( )<=3); Boolean AND and OR operators between clauses (e.g., Part[1].Role=“FX Trader” AND Part2.Role=“FX Buyer”); support concept of Internal and External referring to other Users within the same Member (Internal) or outside of that Member (External).

In step 640, one or more actions to be performed when policy satisfied are defined. Policies can support Rule Consequent Actions, such as ALLOW and BLOCK. Policies can support clauses that indicate Communicate With, Cannot Communicate With (e.g. Block).

The following are examples of policies that may be created:

### Part[1].Role=“FX Trader” AND Part[2].Role=“FX Buyer” AND Part.Count( )=2=>ALLOW

### Part[1].Role=“FX Trader” AND Part[1].Country=“US” AND Part[2].Role=“FX Buyer” AND Part[2].Country=“US” AND Part.Count( )=2=>ALLOW

### Part[1].Role=“FX Trader” AND Part[2].Role=“FX Submitter” AND Part.Count( )=2=>BLOCK

### Part[1].Role=“FX Trader” AND Member[1].Name=“Acme Bank” AND Member.Count( )>=2=>BLOCK

### V. Enforcement of Distributed Ethical Wall Rules

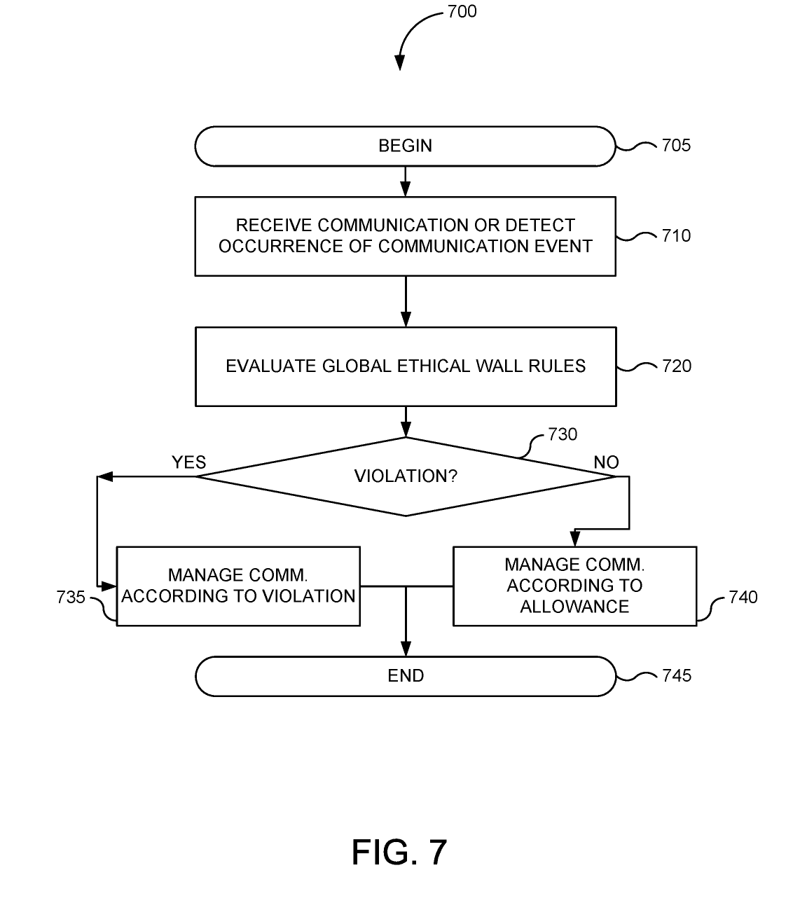

FIG. 7 is a simplified flowchart of method 700 for distributed policy enforcement for enterprise communications in one embodiment. Implementations of or processing in method 700 depicted in FIG. 7 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 700 depicted in FIG. 7 begins in step 705.

In step 710, a communication is received or occurrence of a communication event is detected. A communication can include any type of electronic message (e.g., email, instant message, social media communication, SMS, text, etc.), a phone call, or the like. A communication refers to the act of imparting or exchanging of information, a collaboration, or the means of connection between entities that are parties to a communication or collaboration. Further examples of a communication include a voice call, a conference call, a Voice over Internet Protocol (VoIP) call, a video call, an instant messaging (IM) session, a persistent chat discussion, etc. together with the means that provide such. In various embodiments, communications (e.g., their establishment, content, means, and lifecycle) are controlled by ethical wall rules. A communication event refers to one or more actions or interactions associated with a communication. Further examples of a communication event include establishing a communication session, adding a user to a multi-party communication, inviting a user to join a communication (e.g. invite or add a user to a chat room membership), updating user metadata, etc. In some embodiments, a communication or related event can be received directly by a communications manager or forwarded by another communications manager.

In step 730, an evaluation is performed as to whether the communication (or event) violates one or more global ethical wall rules. Global ethical wall rules generally refer to one or more rules, policies, or filters that apply to other organizations. An active compliance engine (also known as an ethical wall engine) of the organization can communicate with other active compliance engines of other organizations to collect a set of global ethical wall rules.

If a determination is made in step 730 that a violation of the global ethical wall rules has been found, in step 735, the communication (or event) is managed according to the violation. The communication can be blocked, filtered, edited, or otherwise handled according to one or more actions specified by any violated policy. If a determination is made in step 730 that a violation of has not been found, the communication is managed in step 740 according to allowance of the communication. In some embodiments, the communication can be logged, modified with a disclaimer, etc. before being allow to leave an organizations network.

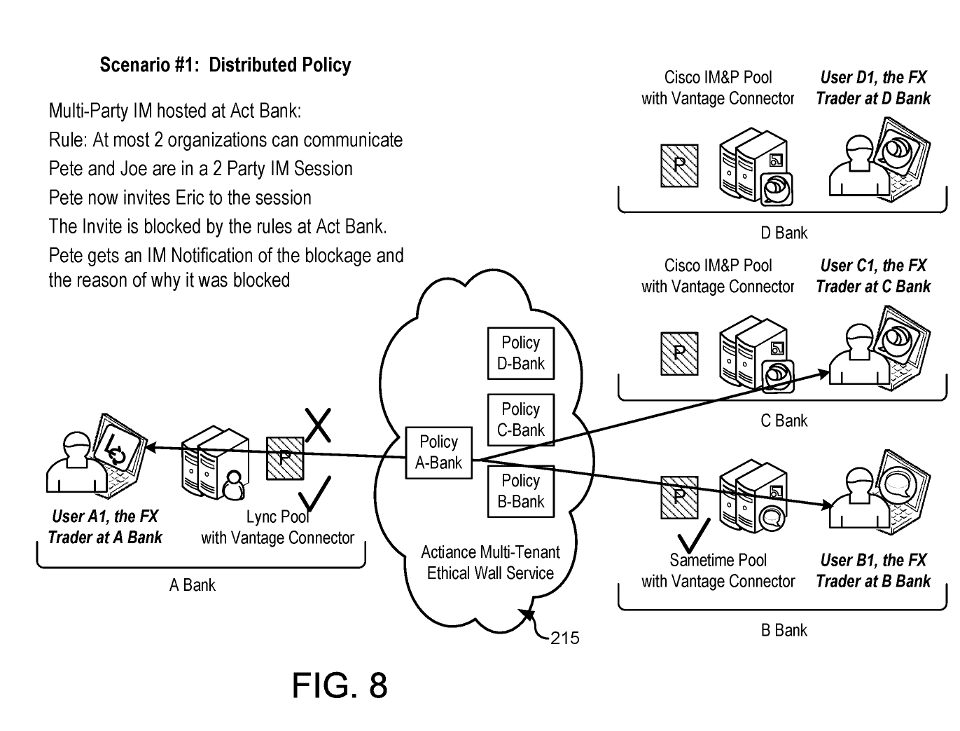

FIG. 8 illustrates one scenario of method 700 of FIG. 7 for distributed policy enforcement for enterprise communications in one embodiment. In this example, a multi-party instant messaging session is being hosted by “A Bank.” User A1 is a FX trader with A, user B1 is a FX trader a “B Bank,” user C1 is a FX trader a “C Bank,” and user D1 is a FX trader a “D Bank.” A has a policy that at most 2 organizations at a time can participate in a chat session. If A1 and B1 are participating in the session and B1 invites C1 to the session, historically there would be no means for A's policy to be enforced. In one embodiment, because A's policy has been shared with B, C, and D using service 215, an event associated with C1's invitation to the session can be detected and a determination made whether the event violates A's policy. The invite can be blocked by implementing A's policy. A notification can be sent to those involved in the session informing them of the block and the reasons.

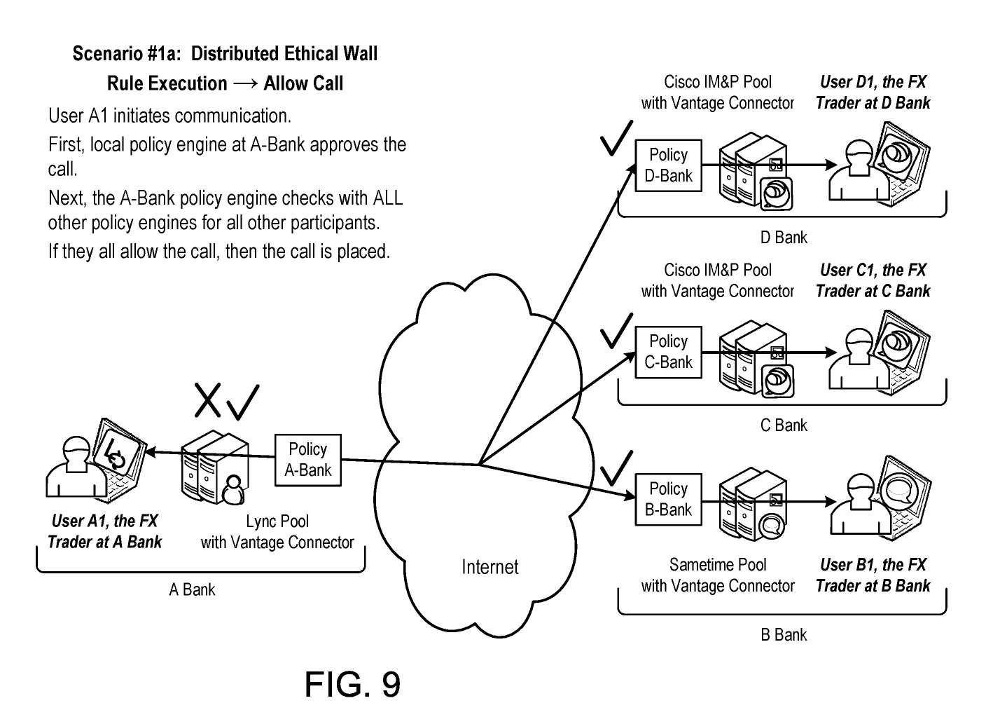

FIG. 9 illustrates how communications are managed in one example for the scenario of FIG. 8 for distributed policy enforcement for enterprise communications in one embodiment.

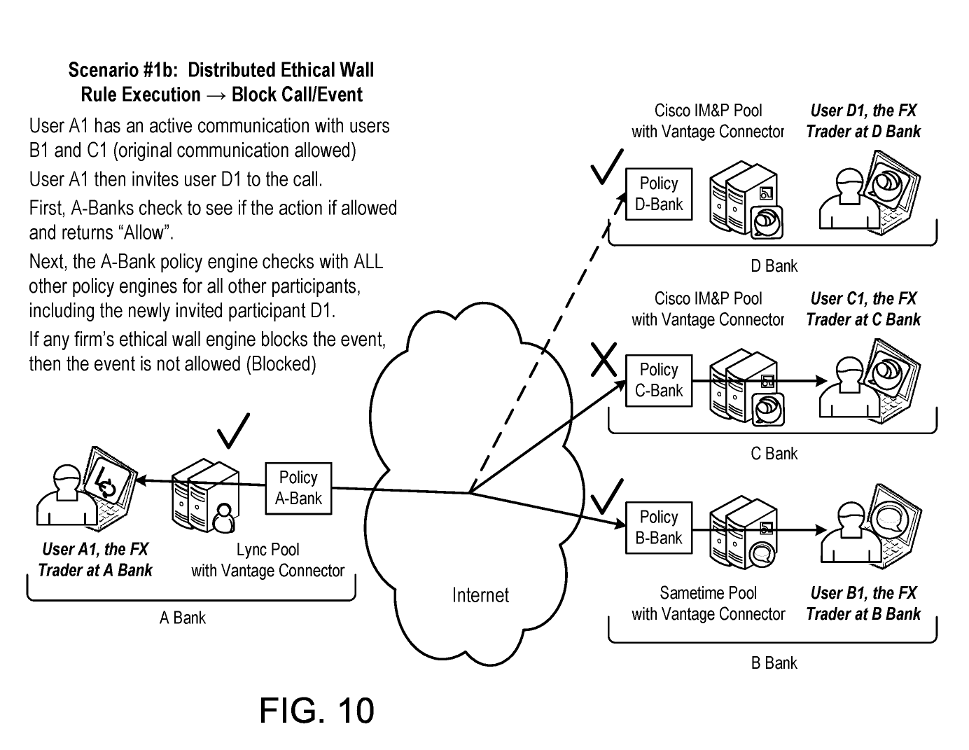

FIG. 10 illustrates how communications are managed in another example for the scenario of FIG. 8 for distributed policy enforcement for enterprise communications in one embodiment.

### VI. Cloud-Based Enforcement of Distributed Ethical Wall Rules

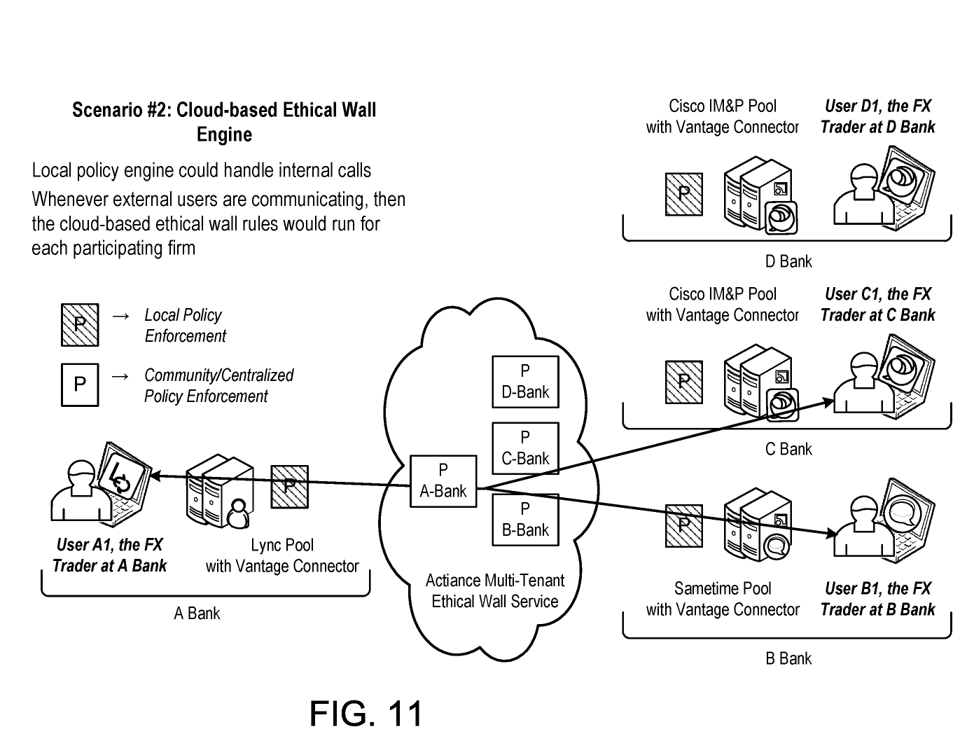

In some embodiments, ethical wall rules can be enforced locally by an entity or organizations and/or the rules could be enforced in the cloud. FIG. 11 illustrates cloud-based distributed policy enforcement for enterprise communications in one embodiment.

In one aspect, local rules are good for high availability, allowing local communications in the event if network access to the cloud ethical wall rule service is down. Whenever a call happens with external participants, the cloud ethical wall rules would be invoked. The rules engine would typically be specific to each firm (and would have privacy settings). Theoretically, a community could have a common set of rules, in which case only 1 rule engine may be invoked.

Some advantages of this approach include:

1. All rules are in 1 place, avoiding the added complexity of having to call the rules engines in multiple different firms.
2. The community metadata would only be in the cloud, where access to this information between firms could be better controlled and monitored. Many firms may not want to share their user directory information with other community members
3. Performance considerations
4. Management considerations (making sure rules have been tested before release, etc.)

### VII. Hybrid Cloud-Based Enforcement of Distributed Ethical Wall Rules

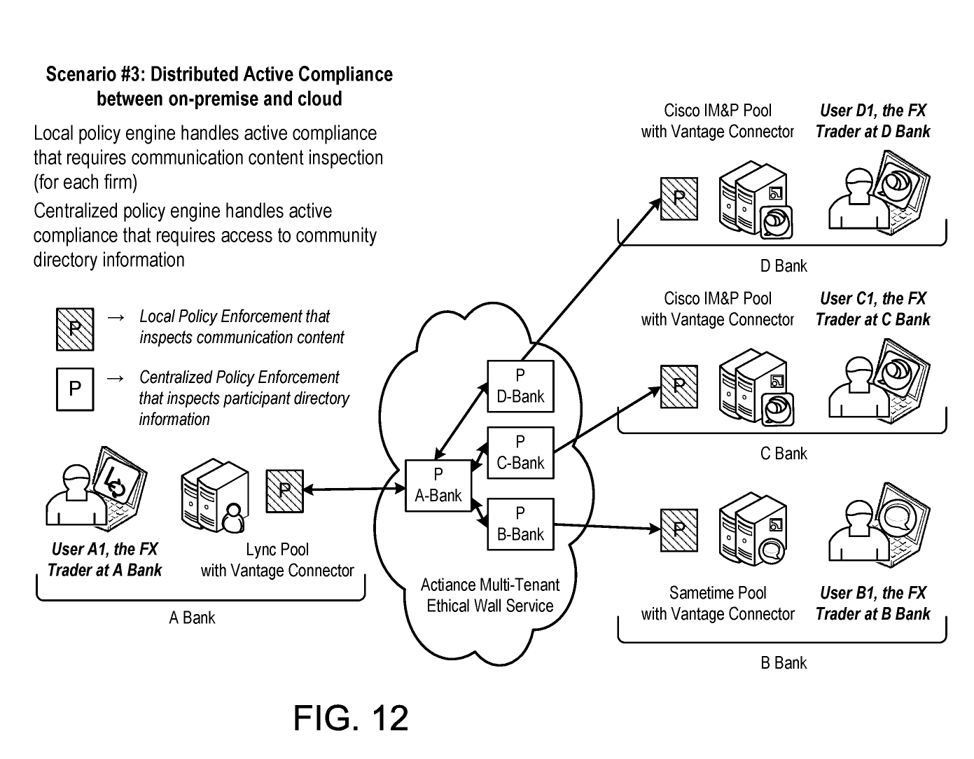

FIG. 12 illustrates distributed active compliance between on-premise and cloud resources for distributed policy enforcement for enterprise communications in one embodiment.

Typically active compliance engines have been deployed on premise. On-premise deployments means the content of the communication can be inspected, giving the local firm control over the privacy of the information. Since these messages contain sensitive content (trades), firms obviously do not want the content inspected by any other party other than the firms participating in the actual communication. Firms typically would not trust a 3rd party from doing this inspection as the 3rd party could monitor communications across the community (which is serious especially in financial service markets).

With the introduction of rich directory information about members of the community (e.g. other financial institutions) that is required for ethical wall engines and rules that enforce policy across the community, firms are put is a position to share this information with other firms or 3rd parties that would apply ethical wall rules. Many firms are reluctant to share this information with a broad set of other firms. This may be due to a number of reasons such as the privacy rights of users or whether the firm trusts or has inspected the other firm's network security to see if it meets their level of satisfaction.

By having the ethical wall rules run in data centers controlled by 1 organization (could be a firm or a neutral 3rd party), then firms can do their network security validation. They also know the location(s) of where this data is in case if there are sensitive countries or country combinations where data should not be shared.

By splitting the active compliance engine so the content inspection is done locally by each firm and the ethical walls enforcement leveraging user information from the community members is done in the cloud means that the security requirements of member firms can best be met.

FIG. 12 shows how the active compliance engine is split, where the P box at each enterprise represents the content inspection component that is run at each enterprise and the P box in the cloud represents the ethical wall engine and community user directory information that is run in the cloud.

Note that select directory information can be shared through actual communications between member firms, possibly controlled by rules of each firm. For example, the policy engine and directory could share information about users in actual conversations between the firms whose users are involved in the communication. This would effectively only share user information between firms where there is actual communication or collaboration (or possibly just that they are both members of a chat room). This level of sharing is useful for transaction resulting from the communication or supervision (watching to make sure only legitimate conversations are taking place). It also means that the actual users have someone obtained the users contact information by some other source (contact list, address book directory service, business card, etc.). This level of sharing means that the firm does not share information about ALL their users across the different members of the community.

### VIII. Example Scenario

In an example, 4 users (A1, B1, C1 and D1) at 4 different firms (A-Bank, B-Bank, C-Bank and D-Bank) respectively are associated in some manner with a communication. An example call might be that user A1 initiates a multi-party IM session with users B1, C1 and D1.

Example events might be:
If A1, B1 and C1 are in a persistent chat room:
   User A1 then tries to invite user D1 to the persistent chat room (in real time or in the future)
   That invite could be allowed or blocked
If A1, B1 and C1 are in a persistent chat room:
   User B1 then tries to invite user D1 to the persistent chat room (in real time or in the future)
   That invite could be allowed or blocked
If A1 is setting up a persistent chat room:
   User A1 then allows B1, C1 and D1 to participate in the chat room.
   The invites would typically be done one after another (but could be done in a batch)
   That “add user(s) event” could be allowed or blocked
If an existing persistent chat room has been created and there are 4 participants (A1, B1, C1 and D1):
   At some point, the user metadata (e.g. user roles) or ethical wall rules (from any or all firms) could be updated
   The system will then (based on some algorithm) would re-evaluate the rules
   At this point, various actions could take place.
   One possible action would be to have the user from any firm where the rules now block his participation would have the user removed from the room. A message could then be sent to the owner and removed user (and others) on the action and reason for the action.
   Typically the owner would still be allowed to access to room (even if all other users are removed).

### IX. Conclusion

In the following description, for the purposes of explanation, specific details are set forth in order to provide a thorough understanding of embodiments of the invention. However, it will be apparent that various embodiments may be practiced without these specific details. The figures and description are not intended to be restrictive.

Systems depicted in some of the figures may be provided in various configurations. In some embodiments, the systems may be configured as a distributed system where one or more components of the system are distributed across one or more networks in a cloud computing system.

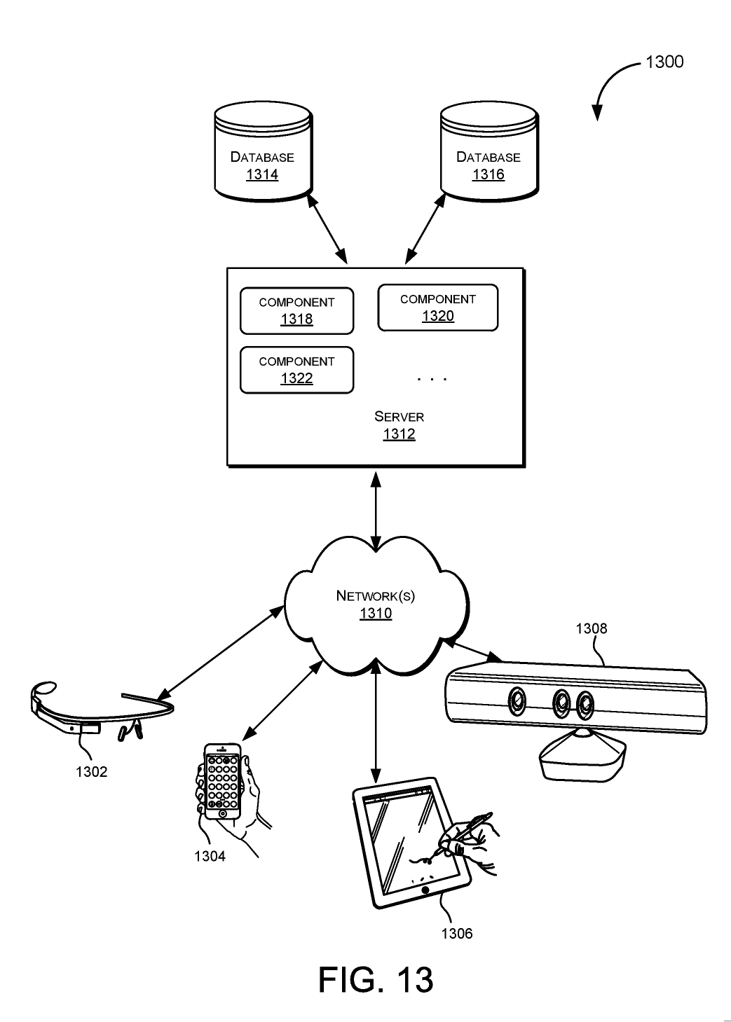

FIG. 13 depicts a simplified diagram of a distributed system 1300 for implementing one of the embodiments. In the illustrated embodiment, distributed system 1300 includes one or more client computing devices 1302, 1304, 1306, and 1308, which are configured to execute and operate a client application such as a web browser, proprietary client (e.g., Oracle Forms), or the like over one or more network(s) 1310. Server 1312 may be communicatively coupled with remote client computing devices 1302, 1304, 1306, and 1308 via network 1310.

In various embodiments, server 1312 may be adapted to run one or more services or software applications provided by one or more of the components of the system. In some embodiments, these services may be offered as web-based or cloud services or under a Software as a Service (SaaS) model to the users of client computing devices 1302, 1304, 1306, and/or 1308. Users operating client computing devices 1302, 1304, 1306, and/or 1308 may in turn utilize one or more client applications to interact with server 1312 to utilize the services provided by these components.

In the configuration depicted in the figure, the software components 1318, 1320 and 1322 of system 1300 are shown as being implemented on server 1312. In other embodiments, one or more of the components of system 1300 and/or the services provided by these components may also be implemented by one or more of the client computing devices 1302, 1304, 1306, and/or 1308. Users operating the client computing devices may then utilize one or more client applications to use the services provided by these components. These components may be implemented in hardware, firmware, software, or combinations thereof. It should be appreciated that various different system configurations are possible, which may be different from distributed system 1300. The embodiment shown in the figure is thus one example of a distributed system for implementing an embodiment system and is not intended to be limiting.

Client computing devices 1302, 1304, 1306, and/or 1308 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 1302, 1304, 1306, and 1308 may be any other electronic device, such as a thin-client computer, an Internet-enabled gaming system (e.g., a Microsoft Xbox® gaming console with or without a Kinect® gesture input device), and/or a personal messaging device, capable of communicating over network(s) 1310.

Although exemplary distributed system 1300 is shown with four client computing devices, any number of client computing devices may be supported. Other devices, such as devices with sensors, etc., may interact with server 1312.

Network(s) 1310 in distributed system 1300 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk®, and the like. Merely by way of example, network(s) 1310 can be a local area network (LAN), such as one based on Ethernet, Token-Ring and/or the like. Network(s) 1310 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 1302.11 suite of protocols, Bluetooth®, and/or any other wireless protocol); and/or any combination of these and/or other networks.

Server 1312 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 1312 may be adapted to run one or more services or software applications described in the foregoing disclosure. For example, server 1312 may correspond to a server for performing processing described above according to an embodiment of the present disclosure.

Server 1312 may run an operating system including any of those discussed above, as well as any commercially available server operating system. Server 1312 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 1312 may include one or more applications to analyze and consolidate data feeds and/or event updates received from users of client computing devices 1302, 1304, 1306, and 1308. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1312 may also include one or more applications to display the data feeds and/or real-time events via one or more display devices of client computing devices 1302, 1304, 1306, and 1308.

Distributed system 1300 may also include one or more databases 1314 and 1316. Databases 1314 and 1316 may reside in a variety of locations. By way of example, one or more of databases 1314 and 1316 may reside on a non-transitory storage medium local to (and/or resident in) server 1312. Alternatively, databases 1314 and 1316 may be remote from server 1312 and in communication with server 1312 via a network-based or dedicated connection. In one set of embodiments, databases 1314 and 1316 may reside in a storage-area network (SAN). Similarly, any necessary files for performing the functions attributed to server 1312 may be stored locally on server 1312 and/or remotely, as appropriate. In one set of embodiments, databases 1314 and 1316 may include relational databases, such as databases provided by Oracle, that are adapted to store, update, and retrieve data in response to SQL-formatted commands.

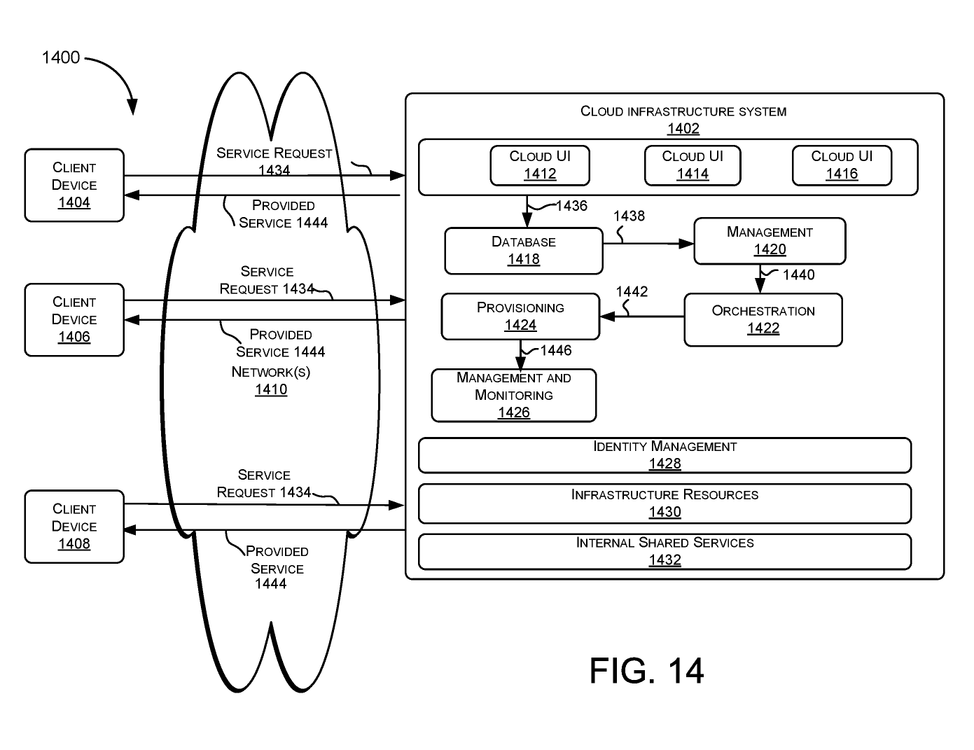

FIG. 14 is a simplified block diagram of one or more components of a system environment 1400 by which services provided by one or more components of an embodiment system may be offered as cloud services, in accordance with an embodiment of the present disclosure. In the illustrated embodiment, system environment 1400 includes one or more client computing devices 1404, 1406, and 1408 that may be used by users to interact with a cloud infrastructure system 1402 that provides cloud services. The client computing devices may be configured to operate a client application such as a web browser, a proprietary client application (e.g., Oracle Forms), or some other application, which may be used by a user of the client computing device to interact with cloud infrastructure system 1402 to use services provided by cloud infrastructure system 1402.

It should be appreciated that cloud infrastructure system 1402 depicted in the figure may have other components than those depicted. Further, the embodiment shown in the figure is only one example of a cloud infrastructure system that may incorporate an embodiment of the invention. In some other embodiments, cloud infrastructure system 1402 may have more or fewer components than shown in the figure, may combine two or more components, or may have a different configuration or arrangement of components.

Client computing devices 1404, 1406, and 1408 may be devices similar to those described above for 1402, 1404, 1406, and 1408.

Although exemplary system environment 1400 is shown with three client computing devices, any number of client computing devices may be supported. Other devices such as devices with sensors, etc. may interact with cloud infrastructure system 1402.

Network(s) 1410 may facilitate communications and exchange of data between clients 1404, 1406, and 1408 and cloud infrastructure system 1402. Each network may be any type of network familiar to those skilled in the art that can support data communications using any of a variety of commercially-available protocols, including those described above for network(s) 1410.

Cloud infrastructure system 1402 may comprise one or more computers and/or servers that may include those described above for server 1412.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1402 may include a suite of applications, middleware, and database service offerings that are delivered to a customer in a self-service, subscription-based, elastically scalable, reliable, highly available, and secure manner. In various embodiments, cloud infrastructure system 1402 may be adapted to automatically provision, manage and track a customer's subscription to services offered by cloud infrastructure system 1402. Cloud infrastructure system 1402 may provide the cloud services via different deployment models. For example, services may be provided under a public cloud model in which cloud infrastructure system 1402 is owned by an organization selling cloud services and the services are made available to the general public or different industry enterprises. As another example, services may be provided under a private cloud model in which cloud infrastructure system 1402 is operated solely for a single organization and may provide services for one or more entities within the organization. The cloud services may also be provided under a community cloud model in which cloud infrastructure system 1402 and the services provided by cloud infrastructure system 1402 are shared by several organizations in a related community. The cloud services may also be provided under a hybrid cloud model, which is a combination of two or more different models.

In some embodiments, the services provided by cloud infrastructure system 1402 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1402. Cloud infrastructure system 1402 then performs processing to provide the services in the customer's subscription order.

In some embodiments, the services provided by cloud infrastructure system 1402 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1402 may also include infrastructure resources 1430 for providing the resources used to provide various services to customers of the cloud infrastructure system. In one embodiment, infrastructure resources 1430 may include pre-integrated and optimized combinations of hardware, such as servers, storage, and networking resources to execute the services provided by the PaaS platform and the SaaS platform.

In some embodiments, resources in cloud infrastructure system 1402 may be shared by multiple users and dynamically re-allocated per demand. Additionally, resources may be allocated to users in different time zones. For example, cloud infrastructure system 1430 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1432 may be provided that are shared by different components or modules of cloud infrastructure system 1402 and by the services provided by cloud infrastructure system 1402. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1402 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1402, and the like. In one embodiment, as depicted, cloud management functionality may be provided by one or more modules, such as management module 1420, orchestration module 1422, provisioning module 1424, monitoring module 1426, and identity management module 1428. These modules may include or be provided using one or more computers and/or servers, which may be general purpose computers, specialized server computers, server farms, server clusters, or any other appropriate arrangement and/or combination.

In exemplary operation 1434, a customer using a client device, such as client device 1404, 1406 or 1408, may interact with cloud infrastructure system 1402 by requesting one or more services provided by cloud infrastructure system 1402. In certain embodiments, the customer may access a cloud User Interface (UI), cloud UI 1412, cloud UI 1414 and/or cloud UI 1416. At operation 1436, information may be stored in database 1418. Database 1418 can be one of several databases operated by cloud infrastructure system 1418 and operated in conjunction with other system elements. At operation 1438, the information may be forwarded to management module 1420. In some instances, management module 1420 may be configured to perform billing and accounting functions. At operation 1440, information is communicated to orchestration module 1422. Orchestration module 1422 may utilize the information to orchestrate provisioning of services and resources. In some instances, orchestration module 1422 may orchestrate provisioning of resources for services using the services of provisioning module 1424.

In certain embodiments, orchestration module 1422 enables the management of business processes associated with business logic. At operation 1442, upon receiving a request, orchestration module 1422 may send a request to provisioning module 1424 to allocate resources and configure those resources. Provisioning module 1424 enables the allocation of resources for the services. Provisioning module 1424 provides a level of abstraction between the cloud services provided by cloud infrastructure system 1400 and the physical implementation layer that is used to provision the resources for providing the requested services. Orchestration module 1422 may thus be isolated from implementation details, such as whether or not services and resources are actually provisioned on the fly or pre-provisioned and only allocated/assigned upon request.

At operation 1444, once the services and resources are provisioned, a notification of the provided service may be sent to customers on client devices 1404, 1406 and/or 1408 by order provisioning module 1424 of cloud infrastructure system 1402. At operation 1446, a customer's information may be managed and tracked by management and monitoring module 1426. In some instances, management and monitoring module 1426 may be configured to collect usage statistics for the services, such as the amount of storage used, the amount data transferred, the number of users, and the amount of system up time and system down time.

In certain embodiments, cloud infrastructure system 1400 may include an identity management module 1428. Identity management module 1428 may be configured to provide identity services, such as access management and authorization services in cloud infrastructure system 1400. In some embodiments, identity management module 1428 may control information about customers who wish to utilize the services provided by cloud infrastructure system 1402. Such information can include information that authenticates the identities of such customers and information that describes which actions those customers are authorized to perform relative to various system resources (e.g., files, directories, applications, communication ports, memory segments, etc.) Identity management module 1428 may also include the management of descriptive information about each customer and about how and by whom that descriptive information can be accessed and modified.

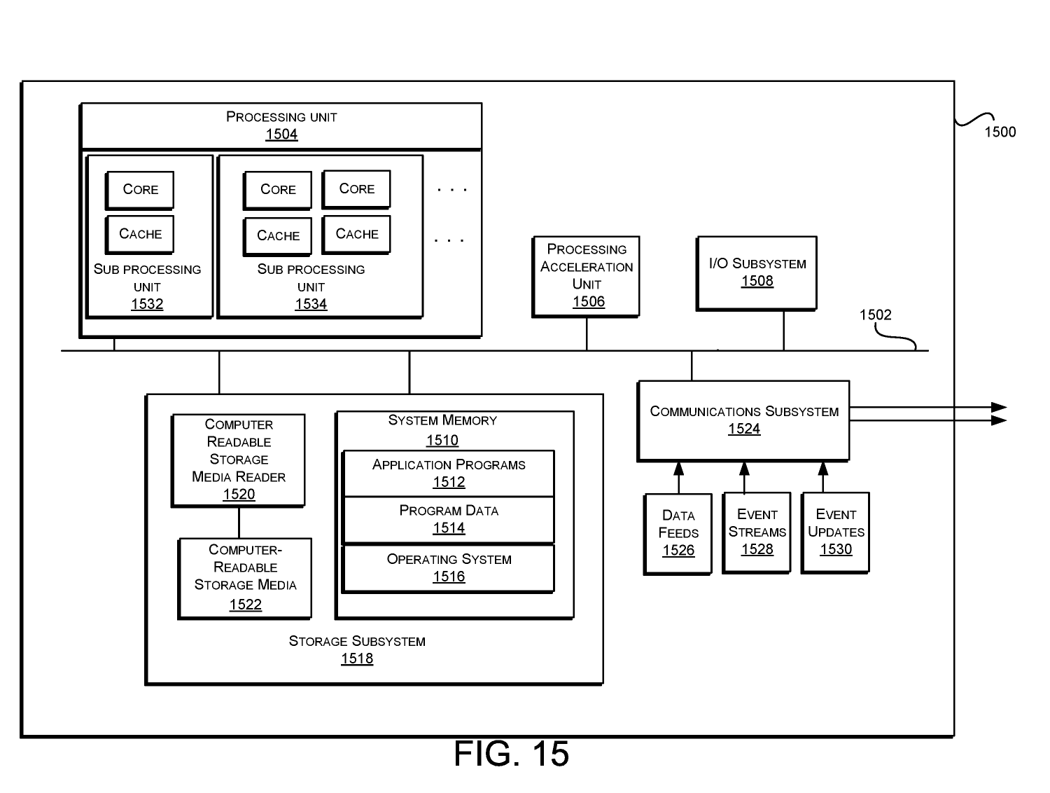

FIG. 15 illustrates an exemplary computer system 1500, in which various embodiments of the present invention may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 760 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 7D scanners, 7D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that comprises software elements, shown as being currently located within a system memory 1510. System memory 1510 may store program instructions that are loadable and executable on processing unit 1504, as well as data generated during the execution of these programs.

Depending on the configuration and type of computer system 1500, system memory 1510 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1504. In some implementations, system memory 1510 may include multiple different types of memory, such as static random access memory (SRAM) or dynamic random access memory (DRAM). In some implementations, a basic input/output system (BIOS), containing the basic routines that help to transfer information between elements within computer system 1500, such as during start-up, may typically be stored in the ROM. By way of example, and not limitation, system memory 1510 also illustrates application programs 1512, which may include client applications, Web browsers, mid-tier applications, relational database management systems (RDBMS), etc., program data 1514, and an operating system 1516. By way of example, operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 15 OS, and Palm® OS operating systems.

Storage subsystem 1518 may also provide a tangible computer-readable storage medium for storing the basic programming and data constructs that provide the functionality of some embodiments. Software (programs, code modules, instructions) that when executed by a processor provide the functionality described above may be stored in storage subsystem 1518. These software modules or instructions may be executed by processing unit 1504. Storage subsystem 1518 may also provide a repository for storing data used in accordance with the present invention.

Storage subsystem 1500 may also include a computer-readable storage media reader 1520 that can further be connected to computer-readable storage media 1522. Together and, optionally, in combination with system memory 1510, computer-readable storage media 1522 may comprehensively represent remote, local, fixed, and/or removable storage devices plus storage media for temporarily and/or more permanently containing, storing, transmitting, and retrieving computer-readable information.

Computer-readable storage media 1522 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1500.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 7G, 4G or EDGE (enhanced data rates for global evolution), WiFi (IEEE 1502.11 family standards, or other mobile communication technologies, or any combination thereof), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method comprising:
at a server computer having a processor and a memory:
receiving a first set of one or more policies that manage participants of communications associated with a first organization, wherein the first set of policies are designed as sharable with other organizations;
storing the first set of policies in the memory;
receiving a second set of one or more policies that manage participants of communications associated with a second organization, wherein the second set of policies are designed as sharable with other organizations;
storing the second set of policies in the memory;
detecting an event associated with a communication between a first participant of the first organization and a second participant of the second organization that involves a third participant of a third organization;
determining that participation of the third participant in the communication violates one or more policies in the first set of policies or the second set of policies; and
managing the participation of the third participant in the communication based on the one or more policies.

2. The method of claim 1 wherein detecting the event associated with the communication between the first participant of the first organization and the second participant of the second organization that involves the third participant of the third organization comprises detecting initiation of phone call.

3. The method of claim 1 wherein detecting the event associated with the communication between the first participant of the first organization and the second participant of the second organization that involves the third participant of the third organization comprises detecting that the third participant has been invited to a chat session.

4. The method of claim 1 wherein detecting the event associated with the communication between the first participant of the first organization and the second participant of the second organization that involves the third participant of the third organization comprises detecting that the third participant has been invited to a teleconference.

5. The method of claim 1 wherein managing the participation of the third participant in the communication based on the one or more policies comprises blocking the third participant.

6. The method of claim 1 wherein managing the participation of the third participant in the communication based on the one or more policies comprises logging the participation of the third participant.

7. The method of claim 1 wherein managing the participation of the third participant in the communication based on the one or more policies comprises requesting permission for the participation of the third participant.

8. A system comprising:
a processor; and
a memory storing a set of instructions that when executed by the processor cause the processor to:
receive a first set of one or more policies that manage participants of communications associated with a first organization, wherein the first set of policies are designed as sharable with other organizations;
receive a second set of one or more policies that manage participants of communications associated with a second organization, wherein the second set of policies are designed as sharable with other organizations;
detect an event associated with a communication between a first participant of the first organization and a second participant of the second organization that involves a third participant of a third organization;
determine that participation of the third participant in the communication violates one or more policies in the first set of policies or the second set of policies; and
manage the participation of the third participant in the communication based on the one or more policies.

9. The system of claim 8 wherein to detect the event associated with the communication between the first participant of the first organization and the second participant of the second organization that involves the third participant of the third organization the processor is caused to detect initiation of phone call.

10. The system of claim 8 wherein to detect the event associated with the communication between the first participant of the first organization and the second participant of the second organization that involves the third participant of the third organization the processor is caused to detect that the third participant has been invited to a chat session.

11. The system of claim 8 wherein to detect the event associated with the communication between the first participant of the first organization and the second participant of the second organization that involves the third participant of the third organization the processor is caused to detect that the third participant has been invited to a teleconference.

12. The system of claim 8 wherein to manage the participation of the third participant in the communication based on the one or more policies the processor is caused to block the third participant.

13. The system of claim 8 wherein to manage the participation of the third participant in the communication based on the one or more policies the processor is caused to log the participation of the third participant.

14. The system of claim 8 wherein to manage the participation of the third participant in the communication based on the one or more policies the processor is caused to request permission for the participation of the third participant.

15. A method comprising:
receiving, by a computer system, an event associated with a communication originating from a first user associated with a first organization;
determining, by the computer system, whether the communication violates a first set of one or more communication policies associated with the first organization;
accessing, by the computer system, a cloud-based service to determine whether the communication violates a second set of one or more communication policies associated with a second organization; and
managing, by the computer system, the communication based on the first set of policies and the second set of policies.

16. The method of claim 15 wherein accessing, by the computer system, the cloud-based service to determine whether the communication violates a second set of one or more communication policies associated with a second organization comprises:
requesting the second set of policies from the service; and
determining whether the communication violates the second set of policies.

17. The method of claim 15 wherein accessing, by the computer system, the cloud-based service to determine whether the communication violates a second set of one or more communication policies associated with a second organization comprises:
sending a request to the service for a determination; and
receiving a response indicating whether the communication violates the second set of policies.

18. The method of claim 15 wherein managing the communication based on the first set of policies and the second set of policies comprises blocking the communication.

19. The method of claim 15 wherein managing the communication based on the first set of policies and the second set of policies comprises allowing the communication.

20. The method of claim 15 wherein managing the communication based on the first set of policies and the second set of policies comprises logging, filtering, or modifying the communication.
